(19) United States
(12) Patent Application Publication
(10) Pub. No.: US 2024/0349927 A1
(43) Pub. Date: Oct. 24, 2024

(54) JUICER AND BLENDER APPARATUS WITH MANUALLY-ACTIVATED EXTRACTION MEANS

(71) Applicant: Danilo Sena, Bountiful, UT (US)

(72) Inventor: Danilo Sena, Bountiful, UT (US)

(21) Appl. No.: 18/302,317

(22) Filed: Apr. 18, 2023

(51) Int. Cl. A47J 19/02

(52) U.S. Cl. CPC A47J 19/02

(57) ABSTRACT

The objective of the present invention is to provide a juicer with optimal, manual extraction and grinding function. To achieve the objective, the present invention has a cylindrical housing for fruits or vegetables which detachably affixes within an L-shaped docking station. A lever and plurality of gears operate to mix, grind, and blend fruits, vegetables or other perishables within the cylindrical housing while the housing is in a docked configuration.

### BACKGROUND

### Field of the Invention

This invention relates to perishable foods and food preparation systems, and more particularly relates to an apparatus for extracting juice from fruits or vegetables.

### Description of the Related Art

A juicer typically has a driving mechanism, often comprising an electric motor for driving a reamer on which a plurality of claw shaped projections squeeze the pulp or flesh of fruits and vegetables for juice extraction. Because of the necessity of fruit cutting before putting the fruit on a reamer, the conventional juice extraction process can be dangerous for operators, including children. An inefficiency of the juicers of the prior art is the exposition of the projections the user's fingers. Additionally, electrical and electromechancial components may fail and are not as reliable as hand-operated apparati.

There exist no, efficient, hand operated, juicers in the art and a need exists for such a device.

### SUMMARY

From the foregoing discussion, it should be apparent that a need exists for a hand-operated, juicer. Accordingly, the present invention has been developed to provide a juicing apparatus comprising: a cylindrical receptacle for housing raw fruit matter; an L-shaped docking station have a planar lower surface; a sidewall rising superiorly from the lower surface; an L-shaped handle adapted to rotate axially about an axis point defined by the sidewall; a first gear affixed to the handle and operable to rotate axially when the handle is turned; a second gear comprising two or more prongs adapted to snap into a mounting point, the second gear mechanically inconnected with the first gear such that the second gear rotates axially in a direction opposing the first gear; and a tertiary gear mechanically interconnected with the second gear, the tertiary gear adapted to rotate a reamer or chuck.

The chuck may rotate to perform one or more of the following functions within the cylindrical receptacle: stirring, grinding, juicing.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a side perspective view illustrating one embodiment of a hand-operated juicer and juice extraction implement in accordance with the present invention;

FIG. 1B is an exploded side perspective view illustrating one embodiment of a hand-operated juicer and juice extraction implement in accordance with the present invention;

FIG. 2 is a side perspective view illustrating one embodiment of a crank of a hand-operated juicer and juice extraction implement in accordance with the present invention;

FIG. 3 is a side perspective view illustrating one embodiment of a crank of a hand-operated juicer and juice extraction implement in accordance with the present invention;

FIG. 4 is a side perspective view illustrating one embodiment of a crank of a hand-operated juicer and juice extraction implement in accordance with the present invention;

FIG. 5 is a side perspective view illustrating one embodiment of a crank of a hand-operated juicer and juice extraction implement in accordance with the present invention;

FIG. 6 is a side perspective view illustrating one embodiment of a crank of a hand-operated juicer and juice extraction implement in accordance with the present invention;

FIG. 7 is a side perspective view illustrating one embodiment of an internal mechanism of hand-operated juicer and juice extraction implement in accordance with the present invention;

FIG. 8 is a side perspective view illustrating one embodiment of an internal mechanism of a hand-operated juicer and juice extraction implement in accordance with the present invention;

FIG. 9 is a side perspective view illustrating one embodiment of a docking station of a hand-operated juicer and juice extraction implement in accordance with the present invention;

FIG. 10 is a side perspective view illustrating one embodiment of a hand-operated juicer and juice extraction implement in accordance with the present invention;

FIG. 11 is a side perspective view illustrating one embodiment of a hand-operated juicer and juice extraction implement in accordance with the present invention;

FIG. 12 is a side perspective view illustrating one embodiment of a hand-operated juicer and juice extraction implement in accordance with the present invention;

FIG. 13 is a side perspective view illustrating one embodiment of a hand-operated juicer and juice extraction implement in accordance with the present invention; and

FIG. 14 is a side perspective view illustrating one embodiment of a hand-operated juicer and juice extraction implement in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention to provide a juicer with optimal, manual extraction and grinding function. To achieve the objective, the present invention has a cylindrical housing for fruits or vegetables which detachably affixes within an L-shaped docking station. A lever and plurality of gears operate to mix, grind, and blend fruits, vegetables or other perishables within the cylindrical housing while the housing is in a docked configuration.

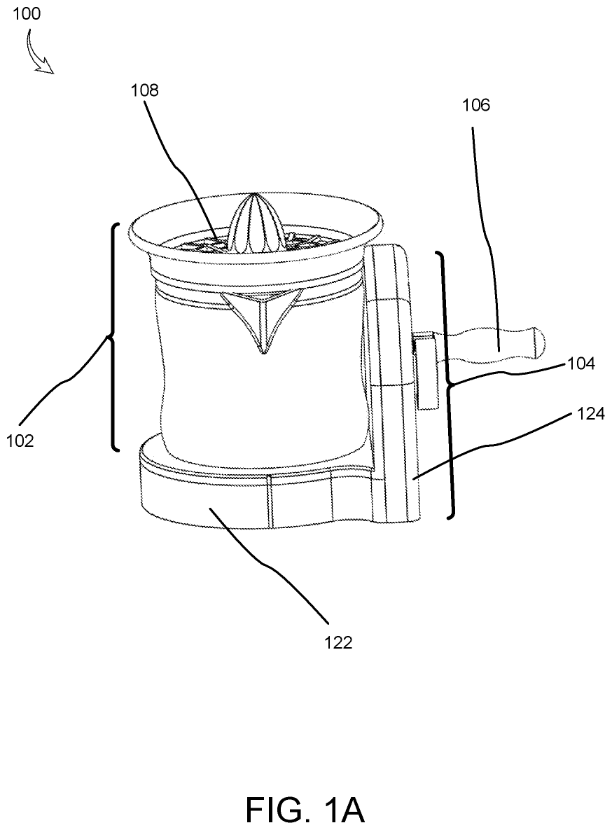

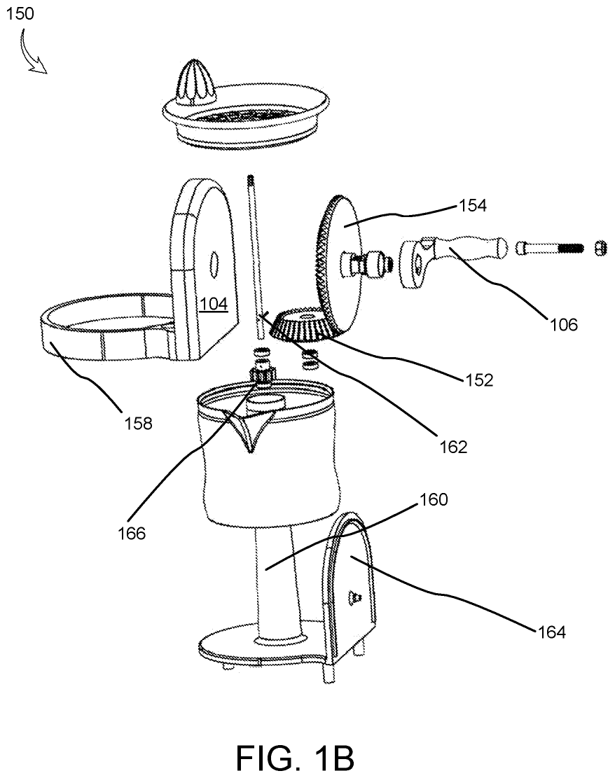

FIGS. 1A-1B are side perspective views illustrating one embodiment of a hand-operated juicer 100 and juice extraction implement in accordance with the present invention.

The juicer 100, fundamentally, comprises a cylindrical housing 102 (or container or jug), a docking station 104, and a crank or lever 106.

The cylindrical housing 102 (or receptacle) is adapted to receive fresh fruits, vegetables, pulp or other fleshly materials intended for juice extract.

The cylindrical housing 102 positions within a docking station 104 on a planar horizontal member 122. The docking station 104 comprises a sidewall 124 which rises superiorly from the planar lower surface.

In various embodiments, the docking station 104 defines a hollow interior recess 902 within which gears and other components operable to impart function to the apparatus 100 are housed.

The lever or crank 106 comprises an L-shaped handle adapted to twist or axially rotate other components within the apparatus 100.

The apparatus 150 may comprise a plurality of beveled gears 152, 154. In various embodiments, a large beveled gear 154 is directly connected to the handle 106 such that the large beveled gear 154 rotates axially with the handle 106 when turned.

A small beveled gear 152 is oriented/intersects at 90 degrees (a right-angle gear) from the large beveled gear 154 such that the small beveled gear 154 is rotated axially on a horizontal plane when the handle 106 is turned.

The large beveled gear 154 is housed within the sidewall 124 while the small beveled gear 152 is housed within the planar horizontal member 122.

In various embodiments, the L-shaped dock cover 164 comprising a tapering cylindrical protuberance 160 rising superiorly from the planar horizontal member 122. The tapering cylindrical protuberance 160 may comprise a tertiary spur gear 166 and be fixed in place with a threaded rod 162. The tertiary spur gear 166 may be fixed in the same horizontal plane as the small beveled gear 152 and rotate in an opposed direction. The tertiary spur gear 166 may be affixed to the rod 162 (or reamer or chuck).

The docking station 104 may comprise a cylindrical tray 158 in which the receptacle 102 is inserted.

An L-shaped dock cover 164 may position above the planar horizontal member 122 and snap thereto, forming a snap fit therewith.

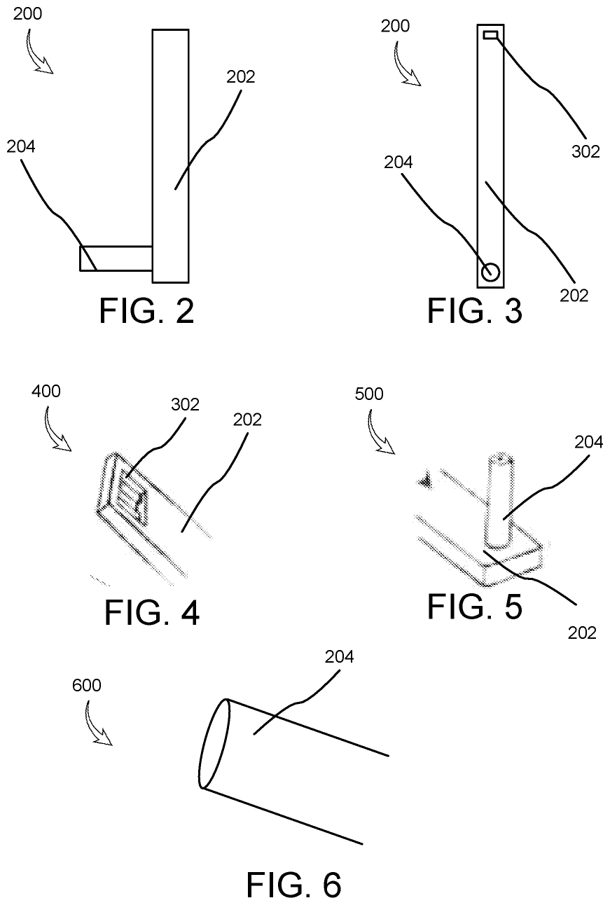

FIGS. 2-6 are perspective views illustrating one embodiment of a crank 200 of a hand-operated juicer and juice extraction implement in accordance with the present invention.

The handle comprises a cantilever 204. The handle 200 may comprise an aperture 302.

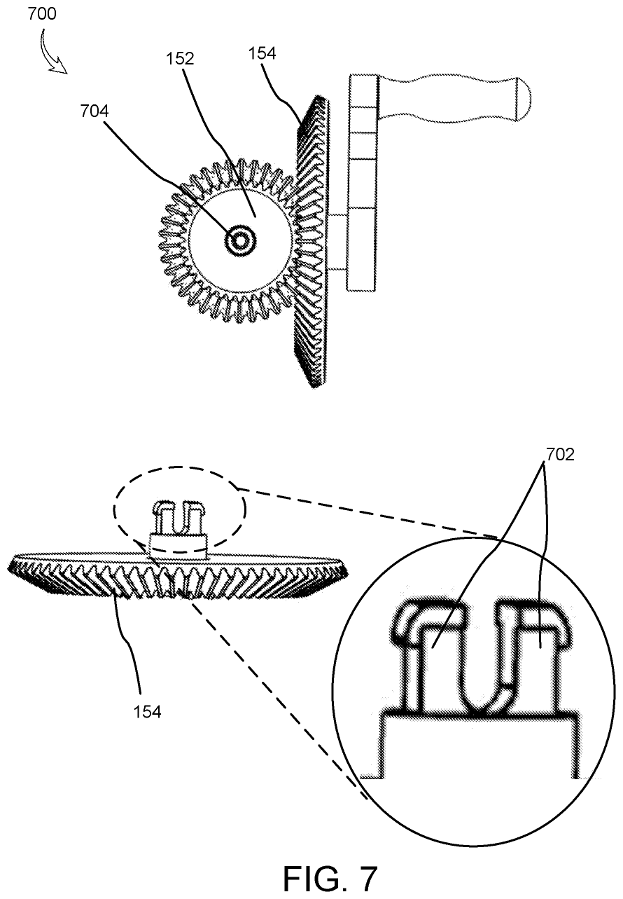

FIG. 7 is a side perspective, exploded view illustrating one embodiment of a hand-operated juicer 700 and juice extraction implement in accordance with the present invention.

The various embodiments, the handle 200, 106 mates with a gear 154 comprising a plurality of teeth. A central aperture 704 disposes within the gear 152.

The large beveled gear 154 may comprises two prongs 702 adapted to snap into the docking station 104, the handle 106, or another mounting point.

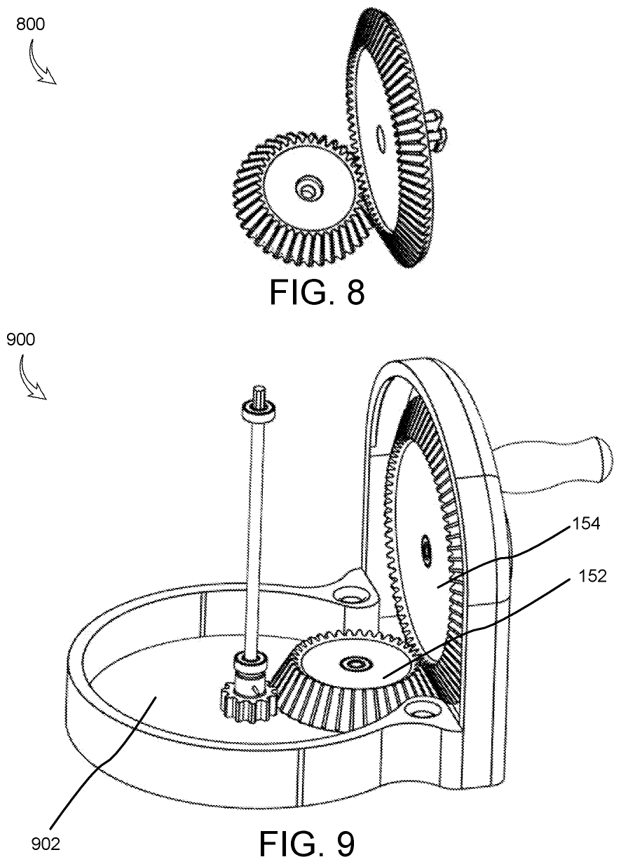

FIG. 8 is a side perspective view illustrating one embodiment of an internal mechanism of a hand-operated juicer and juice extraction implement in accordance with the present invention.

As shown.

FIG. 9 is a side perspective view illustrating one embodiment of a docking station of a hand-operated juicer and juice extraction implement in accordance with the present invention.

As shown.

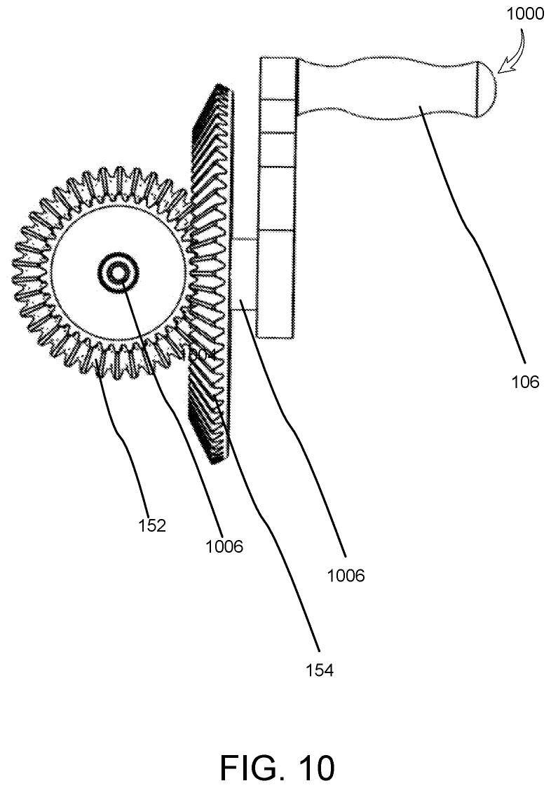

FIG. 10 is a side perspective view illustrating one embodiment of a hand-operated juicer 1000 and juice extraction implement in accordance with the present invention.

In various embodiments, a tertiary spur gear 166 may axially rotate in mechanical connectivity with the larger gear 154 and small gear 152. The apparatus 1000 may comprise a check, or elongated shaft 1006, which rotates to stir the contents of the cylindrical receptacle 102 and which sits between the larger beveled gear 154 and the handle 106.

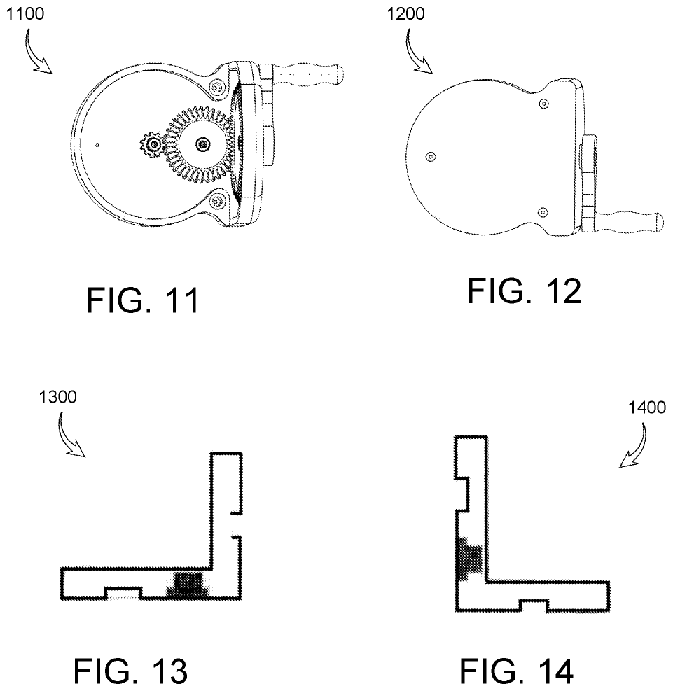

FIGS. 11-14 illustrate side perspective views of various embodiments of a hand-operated juicer and juice extraction implement in accordance with the present invention;

As shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A juicing apparatus comprising:
a cylindrical receptacle for housing raw fruit matter;
an L-shaped docking station have a planar lower surface, the L-shaped docking station comprising a cylindrical tray within which a small beveled gear is housed;
a sidewall rising superiorly from the lower surface, the sidewall housing a larger beveled gear;
an L-shaped handle adapted to rotate axially about an axis point defined by the sidewall;
wherein the small beveled gear is affixed to the handle and operable to rotate axially when the handle is turned;
wherein the large beveled gear comprising two or more prongs adapted to snap into a mounting point, the second gear mechanically interconnected with the small beveled gear such that the small beveled gear rotates axially in a direction opposing the large beveled gear; and
a tertiary gear mechanically interconnected to the small beveled gear, the tertiary gear adapted to rotate a reamer or chuck.

2. The juicing apparatus of claim 1, wherein the chuck rotates to perform one or more of the following functions within the cylindrical receptacle: stirring, grinding, juicing.

3. The juicing apparatus of claim 1, further comprising an L-shaped dock cover positioned superiorly to the cylindrical tray, the L-shaped cover forming a snap fit with the cylindrical tray.

4. The juicing apparatus of claim 1, wherein the L-shaped dock cover further comprising a tapered cylindrical protuberance rising superiorly therefrom.
